(19) United States
(12) Patent Application Publication
(10) Pub. No.: US 2009/0136839 A1
(43) Pub. Date: May 28, 2009

(54) THIN FILM BATTERY COMPRISING STACKED BATTERY CELLS AND METHOD

(75) Inventors: Victor Kraznov, Tarzana, CA (US); Kai-Wei Nieh, Monrovia, CA (US)

Correspondence Address: JANAH & ASSOCIATES A PROFESSIONAL CORP, 650 DELANCEY STREET, SUITE 106, SAN FRANCISCO, CA, 941072001, US

(73) Assignee: Front Edge Technology, Inc.

(21) Appl. No.: 11/946,819

(22) Filed: Nov. 28, 2007

(51) Int. Cl. H01M 6/18; H01M 6/00

(52) U.S. Cl. 429/160; 29/623.1; 29/623.4

(57) ABSTRACT

A stacked battery comprises a first substrate having top and bottom surfaces, and a pair of spaced apart first holes that extend from the top surface to the bottom surface, each first hole having an edge. A first battery cell is on the first substrate, the first battery cell comprising at least a pair of electrode films with an electrolyte therebetween, and a pair of first contact pads, each contact pad contacting an electrode film and an edge of a first hole. A second battery cell is on a second substrate and has a pair of second contact pads that each contact an electrode film and an edge of a first hole. An electrical conductor in each first holes electrically connects a first contact pad to a second contact pad.

### BACKGROUND

Embodiments of the present invention relate to a thin film battery and methods of manufacturing the battery.

A thin film battery comprises a substrate having one or more battery component films that cooperate to store electrical charge and generate a voltage. The battery component films include an electrolyte between electrode films. The electrode films can include an anode, cathode, and/or current collectors. Protective and adhesion layers can also be used. The battery component films are typically less than 400 microns thick, allowing the thin film batteries to be less than about 1/100^{th} of the thickness of conventional batteries. The battery component films are formed by processes, such as for example, physical vapor deposition (PVD), chemical vapor deposition (CVD), oxidation, nitridation, and electroplating.

However, conventional battery component films and substrates often limit the maximum levels of energy density and specific energy that can be obtained conventional batteries. The energy density level is the fully charged output energy level per unit volume of the battery. The specific energy level is the fully charged output energy level per unit weight of the battery. Conventional batteries typically achieve energy density levels of 200 to 350 Whr/L, and specific energy levels of 30 to 120 Whr/L. One reason is that conventional substrates are relatively heavy and reduce the energy to weight ratio. The battery component films also have limited energy storage capabilities and thus limit energy storage levels of the resultant battery. The overall heavier weight and lower levels of energy storage limit the energy density and specific energy of the batteries.

Higher specific energy levels can be achieved for thin battery component films. For example, thick cathodes which have a thickness of 5 microns or more, provide higher energy or charge retention and faster charging and discharging rates. However, it is difficult to fabricate a thick cathode on a substrate as the thick film can delaminate easily or cause surrounding battery component films to peel off. Delamination of the thick cathodes can be reduced by applying an adhesion film on the substrate before the deposition of the cathodes. However, these adhesion films often cause short circuits in or between battery cells, and they can require complex deposition processes. Thus it is desirable to have a battery which provides higher energy density and specific energy levels without being limited by process defects or other limitations.

A further problem arises when it is desirable to use a high energy density battery for diverse applications which require different voltage levels, current levels, or charging and discharging levels. Portable electronic devices may require high discharge currents to power amplifiers and digital signal readers. In contrast, medical devices such as pacemakers require a low discharge current and long battery life. Conventional means included connecting a number of battery cells together by spring and contact connectors to provide the desired voltage, current, or discharge capacities. In certain applications, the battery cells are interconnected with wires running from one battery cell to another. However, both of such battery packs have connector components that are difficult to assemble and which often short circuit or fail during use. The use of a large number of separate connector parts also increases the size of the thin film battery pack to reduce its effective energy density and specific energy levels.

Thus it is desirable to have a thin film battery capable of providing higher energy density and specific energy levels. It is also desirable to reduce the delamination of battery component films, such as electrode or other films and overlying structures. It is further desirable to have a single battery configuration which provides a variety of voltage and current capacities in a single package to meet these diverse applications. It is further desirable to reduce the complexity and number of components that form the thin film battery pack.

### SUMMARY

A stacked battery comprises a first substrate having top and bottom surfaces, and a pair of spaced apart first holes that extend from the top surface to the bottom surface, each first hole having an edge. A first battery cell on the top surface of the first substrate, the first battery cell comprising a plurality of first electrode films having a first electrolyte therebetween, and the first electrode films comprise a pair of first contact pads that each contact an edge of a first hole. A second battery cell on a second substrate, the second battery cell comprising a plurality of second electrode films having a second electrolyte therebetween, and the second electrode films comprising a pair of second contact pads. An electrical conductor in each first hole electrically contacts a first contact pad of the first battery cell, and extends out of each first hole to contact a second contact pad of the second battery cell to electrically connect each first contact pad to a second contact pad.

A method of fabricating a stacked battery comprising interconnect battery cells, comprises providing a first substrate having top and bottom surfaces and forming a pair of spaced apart first holes through the substrate such that each first hole extends from the top surface to the bottom surface and has an edge. Before or after forming the holes, forming at least a portion of a first battery cell on the first substrate, the first battery cell comprising a plurality of first electrode films about a first electrolyte, the first electrode films each comprising a first contact pad, and wherein the first contact pads are positioned such that each first contact pads contacts an edge of a first hole. A second substrate having a second battery cell is provided, the second battery cell comprising a plurality of second electrode films about an electrolyte, and the second electrode films each comprising a second contact pad. An electrical conductor is inserted into each first hole of the first substrate to electrically contact each first contact pad of the first battery cell, and to extend out of each first hole to contact a second contact pad of the second battery cell to electrically connect each first contact pad to a second contact pad.

Another version of the stacked battery comprises a first substrate having top and bottom surfaces, and at least one first hole that extends from the top to the bottom surface, the first hole having an edge. A first battery cell is formed on the top surface of the first substrate and a second battery cell on the bottom surface of the first substrate, the first and second battery cells each comprise a plurality of electrode films about an electrolyte, and the electrode films comprising a pairs of first and second contact pads that each contact an edge of a first hole. An electrical conductor is provided in each first hole to electrically connect a first contact pad to a second contact pad.

A method of fabricating a stacked battery comprises providing a first substrate having top and bottom surfaces, and forming a pair of spaced apart first holes through the substrate such that each first hole extends from the top surface to the bottom surface of the substrate, the first holes comprising edges. Before or after forming the holes, forming at least a portion of a first battery cell on the first substrate, the first battery cell comprising a plurality of electrode films about an electrolyte, the electrode films comprising first contact pads positioned such that each first contact pads contacts an edge of a first hole. A second battery cell is formed on the bottom surface at the first substrate, the second battery cell comprising a plurality of electrode films about an electrolyte, the electrode films comprising second contact pads positioned such that each second contact pad contacts an edge of a first hole. An electrically conductive adhesive is inserted into the pair of first holes to electrically connect each first contact pad to a second contact pad to form a stacked battery.

Another version of a stacked battery comprises first and second substrates. A first substrate comprises top and bottom surfaces, and a pair of spaced apart first holes that extend from the top to the bottom surface, each first hole having an edge; and a top battery cell on a top surface and a bottom battery cell on a bottom surface, each battery cell comprising a plurality of electrode films about an electrolyte, the electrode films comprising first contact pads that each contact an edge of a first hole. A second substrate comprises top and bottom surfaces, and a pair of spaced apart second holes that extend from the top to the bottom surface, each second hole having an edge; and a top battery cell on a top surface and a bottom battery cell on a bottom surface, each battery cell comprising a plurality of electrode films about an electrolyte, the electrode films comprising second contact pads that each contact an edge of a second hole. An electrically insulating adhesive layer adheres the bottom battery cell of the first substrate to the top battery cell of the second substrate. An electrical conductor is provided in each of the first and second holes to electrically connect each first contact pad to a second contact pad.

Another method of fabricating a stacked battery comprises providing first and second substrates that each have top and bottom surfaces. At least one first battery cell is formed on each of the top and bottom surfaces of the first substrate, each battery cell comprising at least a pair of electrode films about an electrolyte, the electrode films including a pair of contact pads. At least one second battery cell is formed on each of the top and bottom surfaces of the second substrate, each battery cell comprising at least a pair of electrode films about an electrolyte, the electrode films including a pair of contact pads. At least a pair of contacts pad on the first substrate are aligned with a pair of contact pads on the second substrate. A pair of spaced apart holes is formed through the first and second substrates such that each hole extends from a top surface to a bottom surface of the substrate, and each hole comprises an edge contacting a contact pad. An electrical conductor is inserted into each hole to electrically connect at least two contact pads to form a stacked battery.

### DRAWINGS

These features, aspects, and advantages of the present invention will become better understood with regard to the following description, appended claims, and accompanying drawings, which illustrate examples of the invention. However, it is to be understood that each of the features can be used in the invention in general, not merely in the context of the particular drawings, and the invention includes any combination of these features, where:

FIG. 1 is a sectional side view of first and second battery cells that are each on a substrate, and are connected to form a stacked battery;

FIG. 2 is a sectional side view of first and second battery cells on the top and bottom surfaces of a single substrate, and which are electrically connected through holes in the substrate;

FIG. 3 is a flowchart of an embodiment of a process for fabricating a stacked battery;

FIG. 4 is a top view of a substrate having a top surface with three battery cells;

FIG. 5 is a schematic sectional side view of a stack of interconnected batteries;

FIG. 6A is a sectional side view of a stacked battery having battery cells that are interconnected through a single hole in a substrate; and

FIG. 6B is a sectional side view of a stacked battery comprising a pair of stacked batteries of FIG. 6A.

### DESCRIPTION

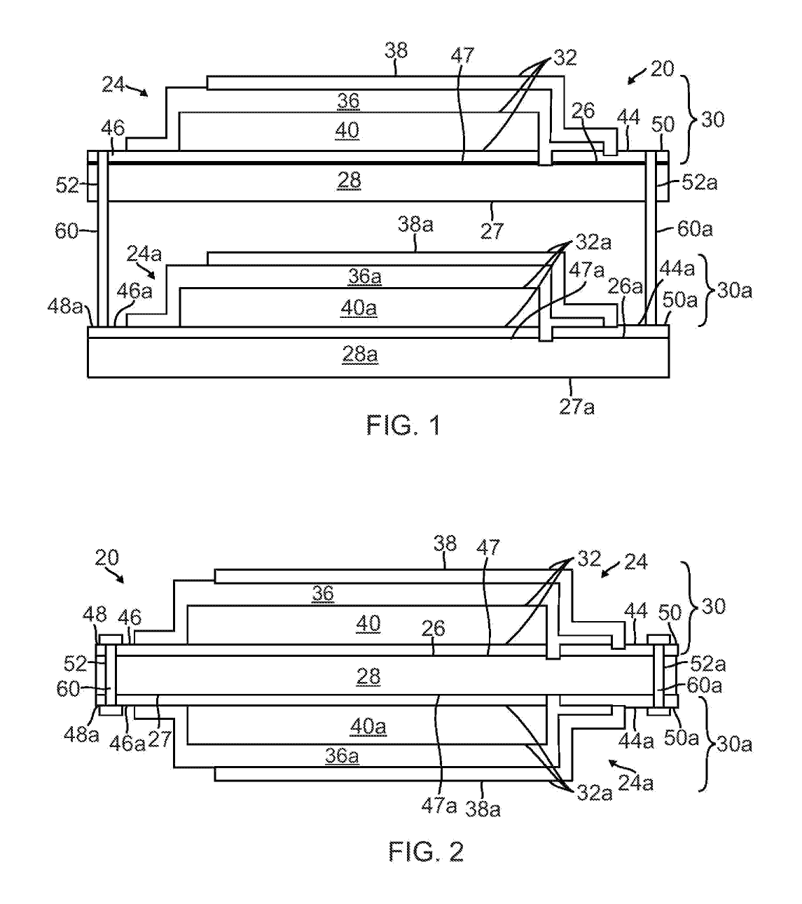

An embodiment of a stacked battery 20 comprises at least two interconnected battery cells 24, 24a, as shown in FIG. 1. In this exemplary version, a single battery cell 24 is shown on each top surface 26, 26a of the substrates 28, 28a, respectively; however, multiple battery cells 24, 24a can also be formed on each of the substrates 28, 28a. A substrate 28 is selected to have desirable surface properties such as a good surface polish, and sufficient mechanical strength to support one or more battery cells 24, 24a during processing and operation. The substrate 28 can be made from insulator, semiconductor, or conductor materials. Suitable substrates 28 can be composed of, for example, ceramic oxides such as aluminum oxide or silicon dioxide; metals such as titanium and stainless steel; semiconductors such as silicon; or even polymers.

In one embodiment, which may be used by itself or in combination with any of the other features or methods described herein, each substrate 28 comprises a sheet of mica. The mica substrate reduces the total weight and volume of the stacked battery 20 while providing sufficient strength to provide the desired mechanical support for the battery 20. The mica substrate typically has a thickness of less than about 100 microns, or even less than about 25 microns. Mica is a muscovite material, which is a layered silicate with a typical stoichiometric ratio of KAl₃Si₃O₁₀(OH)₂. Mica has a flat six-sided monoclinic crystalline structure with cleavage properties that allow mica to be split into thin foils along its cleavage planes to provide thin substrates 28 having large smooth surfaces suitable to receive thin films. Chemically, mica is stable and inert to the action of most acids, water, alkalis and common solvents. Electrically, mica has good dielectric strength, a uniform dielectric constant, and low electrical power loss factors. Mica is also stable at high temperatures of up to 650° C. By using mica, thin substrates 28 may be fabricated to provide lighter and smaller batteries with relatively higher energy density levels. Mica also provides good physical and chemical characteristics for processing of the thin films formed on the substrate 28, in a CVD or PVD chamber, such as for example, a magnetron sputtering chamber.

The first battery cell 24 is formed on the top surface 26 of the first substrate 28. The top surface 26 is planar surface, such as for example, the smooth and flat surface obtained from a cleavage plane of a mica crystal. The battery cell 24 comprises a plurality of battery component films 30 that cooperate to form a battery that can receive and store, or discharge electrical energy. The battery component films 30 include a variety of films which can be employed in a number of different arrangements, shapes and sizes. The first battery cell 24 comprises at least a pair of electrode films 32 about an electrolyte 36. For example, the electrode films 32 comprise electrical conductor films that can include an anode 38, cathode 40, current collectors 44, 46, and/or contact pads 48,50. The electrolyte 36 between the electrode films 32 provides the source of electrons, the electrode films 32 collect the electrons to generate an electrical charge, and the contact pads 48,50 conduct the electrical charge to the external environment.

The exemplary battery cells 24 illustrated herein are provided to demonstrate features of the battery cells 24 and to illustrate their processes of fabrication; however, it should be understood that alternative battery structures as would be apparent to those of ordinary skill in the art are within the scope of the present invention. For example, the electrode films 32 which include one or more of the anode 38, cathode 40, current collectors 44, 46, and contact pads 48,50, can serve each other's functions and consequently are inter-replaceable with one another. As another example, the battery cell 24 can include either a pair of electrode films 32 comprising an anode 38 and cathode 40; a pair of current collectors 44, 46; both the anode 38/cathode 40 and the current collectors 44, 46; or various combinations of these films. One such suitable combination includes an anode 38, cathode 40, and anode current collector 44—where a portion of the cathode and anode current collector 44 extend out of the battery cell to form the contact pads 48,50. The battery cell 24 can also include other battery component films 30, such as an underlying adhesion film 47 and overlying protective films or packaging.

The pair of first contact pads 48, 50 of the first battery cell 24 can form a portion of the electrode films 32, or can be separate structures that connect to a current collector 44, 46 or to the anode 38 or cathode 40. The first contact pads 48, 50 serve as either positive or negative connectors for the first battery cell 24 to connect the first battery cell 24 to the external environment. Each first contact pad 48, 50 also abuts a first hole 52, 52a, respectively, in the substrate 28. The pair of first holes 52, 52a are spaced apart from one another across the first substrate 28. The first contact pads 48, 50 and first holes 52, 52a serve as electrical connectors to allow an electrical connection to be setup between the first battery cell 24 and another battery cell 24a. In one version, one or more of the contact pads 48, 50 consists of an end of an electrode film 32 that extends sufficiently outward from the other films of the cell to serve as a connector for the battery cell 24. For example, the peripheral portion of an electrode film 32 comprising an anode current collector 44 can serve as a contact pad 50.

Each first hole 52, 52a extends from the top surface 26 to a bottom surface 27 of the substrate 28 and have an edge at the intersection of the hole with the surface of the substrate 28. In one version, first holes 52, 52a extend straight through the substrate 28 and are perpendicular to the top and bottom surfaces. In this version, the first holes 52, 52a are circular and have a diameter of from about 1 to about 10 microns. The depth of the first holes 52, 52a depends on the thickness of the substrate 28, and is typically a depth of from about 10 to about 200 microns. While perpendicularly oriented circular holes 52, 52a are illustrated as an exemplary embodiment, it should be understood that other types of holes 52, 52a can also be used. For example, the first holes 52, 52a can be shaped as slits, ovals or rectangles, and can also extend through the substrate 28 in a tilted or angular orientation.

The stacked battery 20 further includes a second battery cell 24a which is connected to the first battery cell 24. In the version shown, the second battery cell 24a is on a second substrate 28a, and comprises battery component films 30a that include at least a pair of electrode films 32a about an electrolyte 36a, and second contact pads 48a, 50a that each contact one of the electrode films 32a. The second substrate 28a, battery component films 30a, electrode films 32a and electrolyte 36a are made of the same materials as those of the first battery cell 24.

To connect the first and second battery cells 24, 24a to one another, the first contact pads 48, 50 of the first battery cell 24 are aligned to the second contact pads 48a, 50a of the second battery cell 24a. The first and second contact pads 48, 48a and 50, 50a, can be aligned to be connected in a series or parallel arrangement to form a stacked battery 20. For example, the hole 52a on the positive contact pad 50 on the first substrate 28 can be placed over the positive contact pad 50a in the second substrate 28a, and the negative contact pads 48, 48a aligned the same way. Before or after contacting the first contact pads 48, 50 and 48a, 50a to one another, the first holes 52, 52a in the first substrate 28 are filled with electrical conductor 60, 60a to extend over a portion of the contact pads. The electrical conductors 60, 60a filling and extending out of the first holes 52, 52a, each serve as an electrical connector post that electrically connects a first contact pad 48, 50 to a second contact pad 48a, 50a. In one version, the electrical conductor 60, 60a comprises an electrically conducting metal, such as silver, copper or aluminum. The conductors 60, 60a can be a post of conducting material, and can be also made of other shapes or materials.

In one version, the electrical conductors 60, 60a comprise an electrically conductive adhesive, such as silver epoxy. The electrically conductive adhesive advantageously serves as both an electrical conductor and an adhesive that holds the joined sections together. As such, the electrically conductive adhesive can be applied not just into the holes 52, 52a, but also on a portion of the first or second contact pads 48, 50 that surrounds the holes 52, 52a. The electrically conductive adhesive is applied on the metal contacts right next to and around the holes 52, 52a, but kept away from the cells 24, 24a themselves to avoid shorting the cells. The silver epoxy also serves as a protective layer to protect the very thin layers of metal contact films, such as the copper and platinum films. The surrounding electrically conductive adhesive can be applied in a thickness of from about 1 to about 10 microns.

An electrically insulating adhesive 66 can also be applied on the surfaces of the first and second battery cells 24, 24a to join the cells to one another when they are contacted against each other. The electrically insulating adhesive 66 is applied on the cells and surrounding the electrically conductive adhesive 60. The electrically insulating adhesive 66 holds the cells 24, 24a together and forms a barrier between the electrically conductive adhesive 60 and the cells 24, 24a to prevent the electrically conductive adhesive from shorting the cells. A suitable electrically insulating adhesive 66 comprises an electrical A suitable electrically insulating adhesive 66 comprises an electrical specific resistivity larger than 10⁸ ohm·cm. In one version the electrically insulating adhesive 66 comprises an epoxy resin such as Hardman® low viscosity epoxy, available from Royal Adhesives & Sealants, LLC of South Bend, Ind., USA. The electrically insulating adhesive 66 can be applied in a thickness of from about 1 to about 10 microns.

The resultant stacked battery 20 comprises at least first and second battery cells 24, 24a that are interconnected to one another in a series or parallel arrangement. As a result, the combined battery cells 24, 24a provide a higher voltage or total energy capacity, which is also adjustable in terms of voltage, current or discharge capacity, depending on the contact arrangement and number of batteries used. The electrically conductive adhesive 60, 60a filling the holes 52, 52a provides a good conductive pathway for connecting the battery cells 24, 24a. Advantageously, the electrically conductive adhesive 60, 60a serves a dual role, and is both an electrically conductive pathway and an adhesive joining surface.

Each of the battery cells 24, 24a comprises a number of battery component films 30, 30a which are selected based on the desired battery characteristics. In the embodiment shown in FIG. 1, the battery component films 30 include an adhesion film 47 which is used to improve the adhesion of overlying films. A first current collector 46, which may serve as the cathode current collector 46, and a second current collector 44, which may serve as the anode current collector 44, are formed on the adhesion film 47. An electrolyte 36 is formed over the cathode 40. An anode 38 comprising an electrochemically active material is then formed over the cathode 40 and over the current collector 44. Protective films (not shown) can also be formed on the battery cell 24 to provide additional protection from environmental elements.

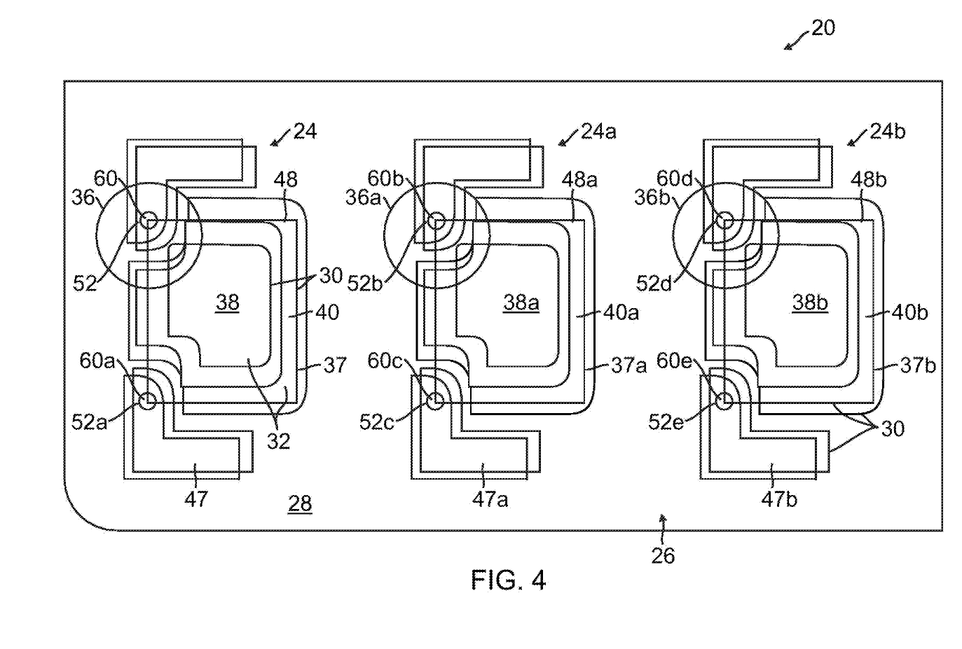

In other versions, the first substrate 28 has a plurality of battery cells 24, 24a on opposing top and bottom surfaces 26, 27 respectively, (as shown in FIG. 2) or on the same surface 26 (as shown in FIG. 4). For example, the first substrate 28 can include a first battery cell 24 on its top surface 26 and a second battery cell 24a on its bottom surface 27, as illustrated in FIG. 2. As another example, the first substrate 28 can include a first, second and third battery cells 24, 24a, 24b, all on the top surface 26 of the substrate 28, is illustrated in FIG. 4. Each battery cell 24 comprises a plurality of battery component films 30 as previously described. The battery cells 24, 24a and 24b can be joined together by surface interconnect lines (not shown) that connect the positive and negative terminals of the battery cells 24, 24a and 24b to one another in a series or parallel arrangement. In addition, the contact pads 48, 50 and abutting holes 52, 52 in each substrate 28 are used to connect the battery cells on the top surface 26 to the battery cells on the bottom surface 27.

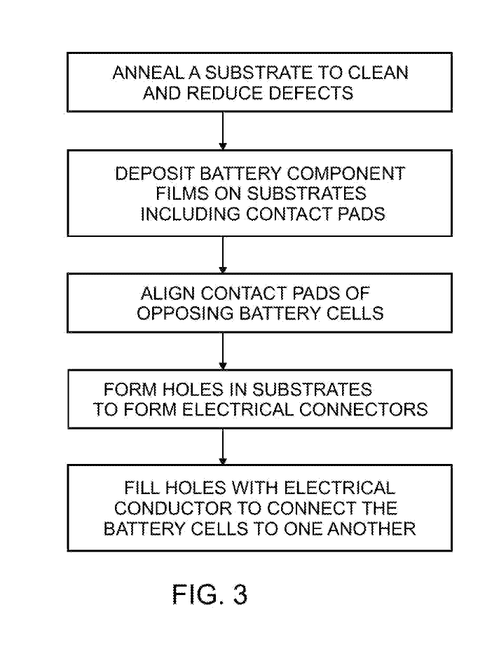

Another embodiment of a method of fabricating a battery cell 24 is illustrated in the flowchart of FIG. 3. To fabricate a battery cell 24, a suitable substrate 28 is selected and annealed to clean the substrate surfaces 26,27 by heating it to temperatures sufficiently high to burn-off contaminants and impurities, such as organic materials, water, dust, and other materials formed or deposited on the top and bottom surfaces 26, 27 of the substrate 28. Such impurities are undesirable because they can cause defects to be formed in the crystalline and other films deposited on the surfaces 26, 27. In an exemplary annealing process, the substrate 28 is annealed to a temperature of from about 150 to about 600° C. For example, the substrate 28 can be annealed to a temperature of at least about 200° C. or even at least about 400° C. The annealing process can be conducted in an oxygen-containing gas, such as oxygen or air, or other gas environments. The oxygen-containing gases burn off the organic materials and contaminants on the substrate 28. The annealing process can also be conducted for about 10 to about 120 minutes, for example, about 60 minutes. The annealing process can also remove water of crystallization which is present within the substrate 28 structure. For example, heat treatment of a mica substrate 28 at temperatures of at least about 540° C. is believed to remove water of crystallization present in the mica microstructure. A suitable annealing furnace 50 comprises a Lindberg convection oven fabricated by Thermo Fisher Scientific, USA.

After substrate annealing, and before or after forming the holes in the substrate, one or more of a plurality of battery component films 30 are deposited on the surfaces 26, 27 of the substrate 28 in a series of process steps. to form the battery cells 24 of a stacked battery 20 that can generate or store electrical charge. While a particular sequence of process steps is described to illustrate an embodiment of the process, it should be understood that other sequences of process steps can also be used as would be apparent to one of ordinary skill in the art. In one version, an adhesion film 47 is initially deposited on the planar surface 26 of the substrate 28 to improve adhesion of overlying battery component films 30 formed on the substrate 28. The adhesion film 47 can comprise a metal or metal compound, such as for example, aluminum, cobalt, titanium, other metals, or their alloys or compounds thereof; or a ceramic oxide such as, for example, lithium cobalt oxide.

A first current collector 46 which serves as a cathode current collector 46 is deposited on top of the adhesion film 47. The current collector 46 is typically a conductor and can be composed of a metal, such as aluminum, platinum, silver or gold. A suitable thickness for the first current collector 46 is from about 0.05 nm to about 2 nm. The current collector 46 serves to collect the electrons during charge and discharge process. The current collector 46 may also comprise the same metal as the adhesion film 47 provided in a thickness that is sufficiently high to provide the desired electrical conductivity. In one example, the first current collector 46 comprises platinum in a thickness of about 0.2 nm.

Thereafter, a cathode 40 comprising an electrochemically active material is then deposited over the patterned current collector 46. In one version, the cathode 40 is composed of lithium metal oxide, such as for example, lithium cobalt oxide, lithium nickel oxide, lithium manganese oxide, lithium iron oxide, or even lithium oxides comprising mixtures of transition metals such as for example, lithium cobalt nickel oxide. Other types of cathodes 40 that may be used comprise amorphous vanadium pentoxide, crystalline V₂O₅ or TiS₂. The cathode 40 can be heated in a stress reducing annealing step to a first temperature of from about 200 to about 500° C. Thereafter, a second film of cathode material is deposited over the first film of cathode material, and this process can be repeated with additional sequential deposition and annealing steps. The resultant stack of films form a cathode 40 having a larger thickness of at least about 5 microns, or even at least about 10 microns. The stacked film cathode 40 can be further annealed to about 150 to about 700° C., for example, 400° C., to reduce defects in the film. In the illustrative example, the cathode 40 comprises crystalline lithium cobalt oxide, which in one version, has the stoichiometric formula of LiCoO₂.

An electrolyte film 36 is formed over the cathode 40. The electrolyte film 36 can be, for example, an amorphous lithium phosphorus oxynitride film, also known as a LiPON film. In one embodiment, the LiPON has the stoichiometric form LiₓPO_{y}N_{z} in an x:y:z ratio of about 2.9:3.3:0.46. In one version, the electrolyte film 36 has a thickness of from about 0.1 microns to about 5 microns. This thickness is suitably large to provide sufficiently high ionic conductivity and suitably small to reduce ionic pathways to minimize electrical resistance and reduce stress.

An anode 38 formed over the electrolyte 36. The anode 38 can be the same material as the cathode 40, as already described. A suitable thickness is from about 0.1 microns to about 20 microns. In one version, anode 38 is made from lithium which is also sufficiently conductive to also serve as the anode current collector 44, and in this version the anode 38 and anode current collector 44 are the same. In another version, the anode current collector 44 is formed on the anode 38, and comprises the same material as the cathode current collector 46 to provide a conducting surface from which electrons may be dissipated or collected from the anode 38. For example, in one version, the anode current collector 44 comprises a non-reactive metal such as silver, gold, platinum, in a thicknesses of from about 0.05 microns to about 5 microns. In still another version, the anode current collector 44 comprises a copper film.

In one exemplary embodiment, portions of the cathode current collector 46 and anode current collector 44 that extend out from under a battery cell 24 form a pair of contact pads 48, 50 that are used to connect the battery cell 24. Thus, in this version, the contact pads 48,50 are made from the same material as anode current collector 44 and cathode current collector 46.

After the deposition of the entire battery cell 24, a variety of different protective layers can be formed over the battery cell 24 to provide protection against environmental elements, as would be apparent to those of ordinary skill in the art. Suitable battery configurations and packaging are described in for example, U.S. patent application Ser. No. 11/090,408, filed on Mar. 25, 2005, entitled “THIN FILM BATTERY WITH PROTECTIVE PACKAGING” by Krasnov et al., which is incorporated by reference herein in its entirety.

The stacked battery can be fabricated using substrates 28 that each have a plurality of battery cells 24, 24a formed on a single substrate 28. For example, FIG. 2 shows first and second battery cells 24, 24a formed on the top surface 26 and bottom surface 27, respectively, of a single substrate 28. Each of the battery cells 24 is fabricated using the same annealing, deposition and other processes. In addition, the battery cells 24 can be formed simultaneously in a single chamber. Alternatively, the battery film components 30 of each battery cell 24 can be formed, in sequence, by forming a first battery cell 24 on a top surface 26 of a substrate 28, and then flipping over the substrate 28 and processing the bottom surface 27 to form the second battery cell 24a.

In addition, multiple cells can be formed on a single surface, for example, the top surface 26 (as shown) as illustrated in FIG. 4, as well as the bottom surface 27 of the same substrate 28 (not shown). In this version, three battery cells 24, 24 a, and 24b are formed on the surface 26, each cell comprising an electrolyte 36a-c, anode 38a-c, cathode 40a-c, current collectors 44a-c, 46a-c, an underlying adhesion film 47a-c, contact pads 48a-c, 50a-c and overlying protective films. Some of the contact pads 48, 50 such as the ones at the two ends of each substrate 28a-c also abut an edge of a hole 52, 52a-e and contact the electrical conductors 60, 60a-e; while other contact pads 48, 50 on the same surface 26 or 27 of the substrate are connected to each other.

Before stacking the battery cells 24, 24a-e together and contacting the first contact pads 48, 50 and 48a, 50a to one another, electrical conductor 60,60a comprising, for example, electrically conductive adhesive 60 such as silver epoxy, is applied in a small area on the metal contact pads. An electrically insulating adhesive 66, such as an epoxy resin, is also applied on the bottom surface of the first battery cell 24 and on the top surface of the second battery cell 24a to join the cells to one another when they are contacted. The electrically insulating adhesive 66 is applied on the cells 24, 24a and surrounding the electrically conductive adhesive 60.

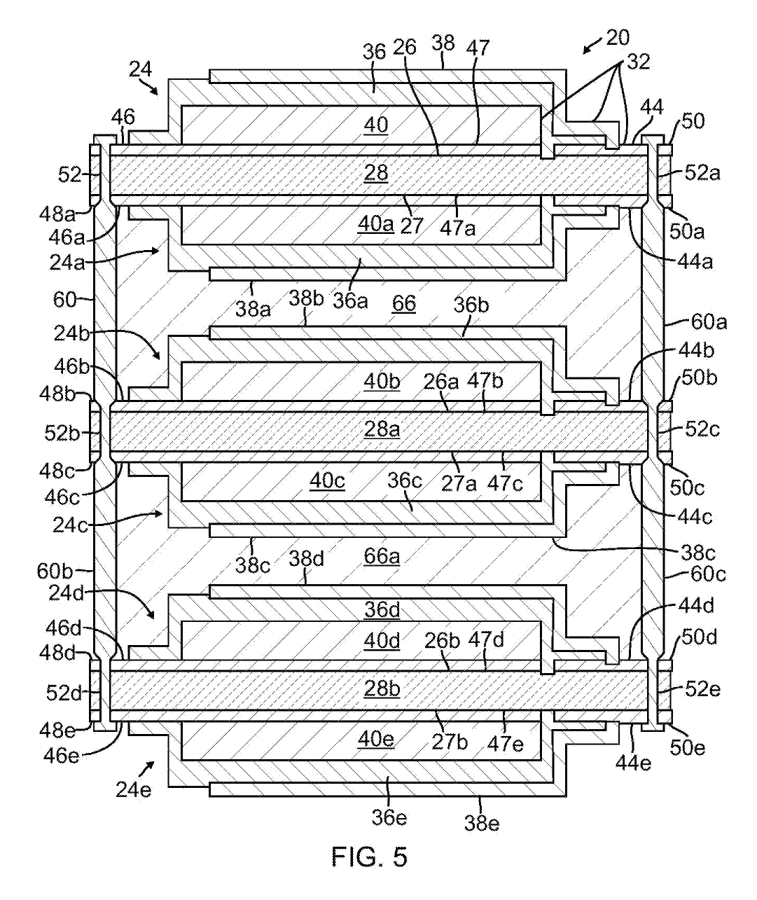

Referring to FIG. 5, the contact pads 48, 48a-e and 50, 50a-e of the battery cells 24, 24a-e then are aligned to, and contacted with each other to allow the electrically conductive 60 adhesive to bond together and the electrically insulating adhesive 66 to bond the battery cells 24, 24a together. Thereafter, the holes 52, 52a-e are formed through all three or more of the substrates 28, 28a, b. For example, the holes 52, 52a-e can be drilled through the battery cells using a conventional mechanical drill or laser drilling apparatus. After the holes 52, 52a-e are drilled, electrical conductive adhesive 60, 60a-c is used to fill the holes 52, 52a-e to electrically connects the first contact pads 48, 48a-e and second contact pads 50, 50a-e to one another. The electrically insulating adhesive 66 holds the cells 24, 24a-e together and forms a barrier between the electrically conductive adhesive and the cells. Thereafter, the stacked battery is cut off at one or more edges of the substrate so that the electrical conductor 60, 60a-c in the filled holes 52, 52a-e is cut through, for example, the holes 52, 52a-e can be bisected. This removes the extraneous edge of the battery substrate and a portion of the electrically conductive adhesive 60, 60a-c in the holes to reduce the overall weight of the battery 20. The resultant stacked battery 20 is a firmly adhered and strong structure with many possible configurations of total voltage and amperage output to meet diverse applications.

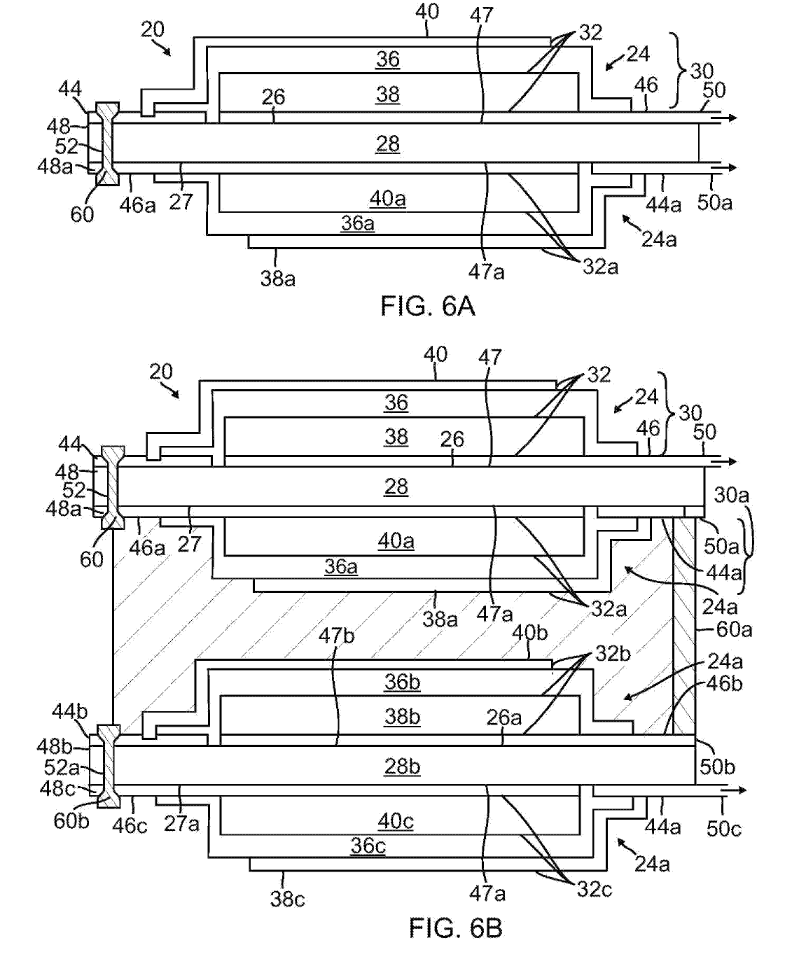

A stacked battery 20 formed by connecting a first battery cell 24 on a top surface 26 of a substrate 28 with a second battery cell 24a on a bottom surface 27 of the substrate 28 is shown in FIG. 6A. The first and second battery cells 24, 24a are connected by an electrical conductor 60 that passes through a hole 52 in the substrate 28 and connects a contact pad 48 of the first cell 24 to a contact pad 48a of the second cell 24a. The first and second cells 24, 24a each have a second contact pad 50, 50a that provides a connection point for connecting the stacked battery 20 to external terminals, load or other stacked batteries.

A stacked battery 20 can be formed from a set of battery cells 24, 24a-c, as shown in FIG. 6B. Two substrates 28, 28a each have a battery cell 24 on a top surface 26 and a bottom surface 27. The positive terminal of the top battery cell 24 is connected to the negative terminal of the bottom battery cell 24a by an electrical connector that extends through a hole in the substrate 28. The battery cells 24, 24a of the first substrate 28 are connected to the battery cells 24b, 24c of the second substrate 28a by an electrical connector 60a that extends between a positive terminal of the bottom battery cell 24a on the first substrate 28 and a negative terminal of the top battery cell 24b on the second substrate 28a. In one exemplary embodiment the electrical connector 60a consists of an electrically conductive adhesive 60. The stacked battery of FIG. 6B comprises electrically insulating adhesive 66 in between the substrates 28, 28a. The electrically insulating adhesive 66 holds the cells 24a, 24b together and forms a barrier between the electrically conductive adhesive 60a and the cells 24a, 24b to prevent the electrically conductive adhesive 60a from shorting the cells.

While illustrative embodiments of a battery 20 and battery cells 24 are described in the present application, it should be understood that other embodiments are also possible. Also, other methods of fabricating and joining the battery cells 24 to one another, as would be apparent to those of ordinary skill in the art, are also included in the present application. Thus, the scope of the claims should not be limited to the illustrative embodiments.

What is claimed:

1. A stacked battery comprising:
(a) a first substrate having top and bottom surfaces, and a pair of spaced apart first holes that extend from the top surface to the bottom surface, each first hole having an edge;
(b) a first battery cell on the top surface of the first substrate, the first battery cell comprising a plurality of first electrode films having a first electrolyte therebetween, the first electrode films comprising a pair of first contact pads that each contact an edge of a first hole;
(c) a second battery cell on a second substrate, the second battery cell comprising a plurality of second electrode films having a second electrolyte therebetween, the second electrode films comprising a pair of second contact pads; and
(d) an electrical conductor in each first hole that (i) electrically contacts a first contact pad of the first battery cell, and (ii) extends out of each first hole to contact a second contact pad of the second battery cell to electrically connect each first contact pad to a second contact pad.

2. A battery according to claim 1 wherein the electrical conductors comprise electrically conductive adhesive.

3. A battery according to claim 2 wherein the electrically conductive adhesive comprises silver epoxy.

4. A battery according to claim 1 wherein the electrically conductor extends over a portion of each first contact pad that surrounds a first hole.

5. A battery according to claim 1 further comprising electrically insulating adhesive to join the first and second battery cells to one another.

6. A battery according to claim 1 wherein the first substrate comprises a perimeter, and wherein the first holes are on the perimeter of the first substrate.

7. A battery according to claim 1 wherein the first holes comprise at least one of (i) an opening dimension of from about 0.1 to about 4 mm, and (ii) a depth of from about 10 to about 200 microns.

8. A battery according to claim 1 wherein the first or second contact pads form either positive or negative connectors.

9. A battery according to claim 1 wherein the electrode films include an anode, a cathode, and at least one current collector, and wherein the first and second substrates comprise mica.

10. A battery according to claim 1 comprising:
(e) a third battery cell on the bottom surface of the first substrate, the third battery cell comprising third electrode films having a third electrolyte therebetween, and the third electrode films comprising a pair of third contact pads that each contact an edge of a first hole, and
wherein the portion of the electrical conductor extending out of the first hole covers a portion of each third contact pad.

11. A method of fabricating a stacked battery comprising interconnected battery cells, the method comprising:
(a) providing a first substrate having top and bottom surfaces;
(b) forming a pair of first holes through the substrate that are spaced apart and extend from the top surface to the bottom surface of the substrate, each first hole having an edge;
(c) before or after (b), forming at least a portion of a first battery cell on the first substrate, the first battery cell comprising a plurality of first electrode films about a first electrolyte, the first electrode films each comprising a first contact pad, and wherein the first contact pads are positioned such that each first contact pads contacts an edge of a first hole;
(d) providing a second substrate having a second battery cell, the second battery cell comprising a plurality of second electrode films about an electrolyte, and the second electrode films each comprising a second contact pad; and
(e) inserting electrical conductor into each first hole of the first substrate to electrically contact each first contact pad of the first battery cell, and to extend out of each first hole to contact a second contact pad of the second battery cell to electrically connect each first contact pad to a second contact pad.

12. A method according to claim 11 wherein the electrically conductor extends over a portion of each first contact pad that surrounds a first hole.

13. A method according to claim 11 comprising cutting the first substrate form a perimeter that cuts through the first holes.

14. A method according to claim 11 further comprising applying electrically insulating adhesive on the first or second battery cells to join the first and second battery cells to one another.

15. A method according to claim 14 wherein (e) comprises inserting electrical conductor comprising an electrically conductive adhesive.

16. A method according to claim 15 further comprising aligning and contacting the first and second substrates while the electrically conductive adhesive and the electrically insulative adhesive are fluid.

17. A method according to claim 16 further comprises applying a sufficiently high temperature and pressure to the first and second substrates to allow the electrical insulator adhesive to flow and cure.

18. A stacked battery comprising:
(a) a first substrate having top and bottom surfaces, and at least one first hole that extends from the top to the bottom surface, the first hole having an edge;
(b) a first battery cell on the top surface of the first substrate and a second battery cell on the bottom surface at the first substrate, the first and second battery cells each comprising a plurality of electrode films about an electrolyte, and the electrode films comprising a pairs of first and second contact pads that each contact an edge of a first hole; and
(c) an electrical conductor in each first hole to electrically connect a first contact pad to a second contact pad.

19. A method of fabricating a stacked battery, the method comprising:
(a) providing a first substrate having top and bottom surfaces;
(b) forming a pair of spaced apart first holes through the substrate such that each first hole extends from the top to the bottom surface, the first holes comprising edges;
(c) before or after (b), forming at least a portion of a first battery cell on the top surface of the first substrate, the first battery cell comprising a plurality of electrode films about an electrolyte, the electrode films comprising first contact pads positioned such that each first contact pad contacts an edge of a first hole;
(d) before or after (b), forming at least a portion of a second battery cell on the bottom surface of the first substrate, the second battery cell comprising a plurality of electrode films about an electrolyte, the electrode films comprising second contact pads positioned such that each second contact pad contacts an edge of a first hole; and
(e) inserting an electrical conductor into each first hole to electrically connect each first contact pad to a second contact pad to form a stacked battery.

20. A stacked battery comprising:
(a) a first substrate comprising:
(i) top and bottom surfaces, and a pair of spaced apart first holes that extend from the top to the bottom surface, each first hole having an edge; and
(ii) a top battery cell on a top surface and a bottom battery cell on a bottom surface, each battery cell comprising a plurality of electrode films about an electrolyte, the electrode films comprising first contact pads that each contact an edge of a first hole;
(b) a second substrate comprising:
(i) top and bottom surfaces, and a pair of spaced apart second holes that extend from the top to the bottom surface, each second hole having an edge; and
(ii) a top battery cell on a top surface and a bottom battery cell on a bottom surface, each battery cell comprising a plurality of electrode films about an electrolyte, the electrode films comprising second contact pads that each contact an edge of a second hole;
(c) an electrically insulating adhesive layer adhering the bottom battery cell of the first substrate to the top battery cell of the second substrate; and
(d) an electrical conductor in each of the first and second holes to electrically connect each first contact pad to a second contact pad.

21. A battery according to claim 20 wherein the electrical conductor comprises an electrically conductive adhesive.

22. A battery according to claim 21 wherein the electrically conductive adhesive comprises silver epoxy.

23. A method of fabricating a stacked battery, the method comprising:
(a) providing a first and second substrates that each have top and bottom surfaces;
(b) forming at least one first battery cell on each of the top and bottom surfaces of the first substrate, each battery cell comprising at least a pair of electrode films about an electrolyte, the electrode films including a pair of contact pads;
(c) forming at least one second battery cell on each of the top and bottom surfaces of the second substrate, each battery cell comprising at least a pair of electrode films about an electrolyte, the electrode films including a pair of contact pads;
(d) aligning at least a pair of contacts pad on the first substrate with a pair of contact pads on the second substrate;
(e) forming a pair of spaced apart holes through the first and second substrates such that each hole extends from a top surface to a bottom surface of the substrate, and each hole comprises an edge contacting a contact pad; and
(g) inserting an electrical conductor into each hole to electrically connect at least two contact pads to form a stacked battery.
